(19) United States
(12) Patent Application Publication
(10) Pub. No.: US 2014/0116321 A1
(43) Pub. Date: May 1, 2014

(54) METER WITH POINTER

(71) Applicants: DENSO INTERNATIONAL AMERICA, INC., Southfield, MI (US); DENSO CORPORATION, Kariya-City (JP)

(72) Inventor: Hiroshi Tominaga, Kariya-city (JP)

(73) Assignees: DENSO CORPORATION, Kariya-city (JP); DENSO INTERNATIONAL AMERICA, INC., Southfield, MI (US)

(21) Appl. No.: 13/660,151

(22) Filed: Oct. 25, 2012

(51) Int. Cl. G01D 13/12; G01D 13/04

(52) U.S. Cl. 116/286; 116/284

(57) ABSTRACT

A meter has a background board, a pointer, a driving source, and a cover member. The driving source rotates the pointer. The pointer points an indicator to show a value of a variable. The background board is disposed behind the pointer. The cover member is disposed on a front side to the pointer. The cover member is transparent and is disposed between the pointer and a viewer. The indicator is formed on the cover member. As a result, the indicators can be placed on the near side than both the pointer and the background board. It is possible to provide an easy-to-read indicator and a perspective, three-dimensional appearance.

### TECHNICAL FIELD

The disclosure relates to a meter with a pointer.

### BACKGROUND

U.S. Pat. No. 6,519,999 discloses a meter which has a movable pointer driven by a driver module, e.g., a motor. The pointer shows a value of vehicular condition, such as a vehicle speed or an engine rotational speed. The meter has a plurality of indicators, such as scales and numbers. The meter may have a dial board, i.e., a background board, and a pointer. The indicators are placed, e.g. printed, on the dial board along a curved path. The pointer is supported on a center of the circular path to be rotatable about the center. The pointer is disposed in front of the dial board to be placed closer to a viewer, e.g., a driver than the dial board.

### SUMMARY

In the conventional arrangement, the indicators are placed on the dial board disposed behind the pointer. Therefore, the pointer sweeps over the indicators and may cover at least a part of one indicator. In this case, it will become difficult to see the indicator. As a result, it will become difficult for the viewer to recognize or read a value pointed.

It is an object of the present disclosure to provide a meter with pointer which has a high level of visibility at an indicator.

It is another object of the present disclosure to provide a meter with pointer which has an easy-to-read indicator.

It is still another object of the present disclosure to provide a meter with pointer which is capable of showing a perspective, three-dimensional appearance while closely arranging a pointer and an indicator.

According to the disclosure, a meter with a pointer is provided. The meter comprises a pointer which rotates to point an indicator showing a value, a background board disposed behind the pointer, and a driving source which rotates the pointer. The meter comprises a cover member which is transparent. The cover member is disposed on a front side to the pointer to cover the pointer. The cover member has the indicator thereon.

The indicator is placed closer to a viewer than the pointer. Therefore, the indicator is not covered by the pointer. It is possible to provide a meter having a high level of visibility at the indicator. It is possible to provide a meter having an easy-to-read indicator.

It is possible to provide a meter which is capable of showing a three-dimensional appearance having the indicator on a closer layer than that where the pointer and the background board are located.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a front view of a meter according to a first embodiment of the present disclosure;

FIG. 2 is a sectional view on a line II-II in FIG. 1;

FIG. 3 is a sectional view according to a second embodiment of the present disclosure;

FIG. 4 is a sectional view according to a third embodiment of the present disclosure; and

FIG. 5 is a sectional view according to a fourth embodiment of the present disclosure.

### DETAILED DESCRIPTION

Hereinafter, embodiments of the present disclosure are described in detail referring to the attached drawings. In the description, redundant explanation is omitted by using the same reference numbers to indicate the same or corresponding members. In a case that only a part of component or part is described, other descriptions for the remaining part of component or part in the other description may be incorporated.

### First Embodiment

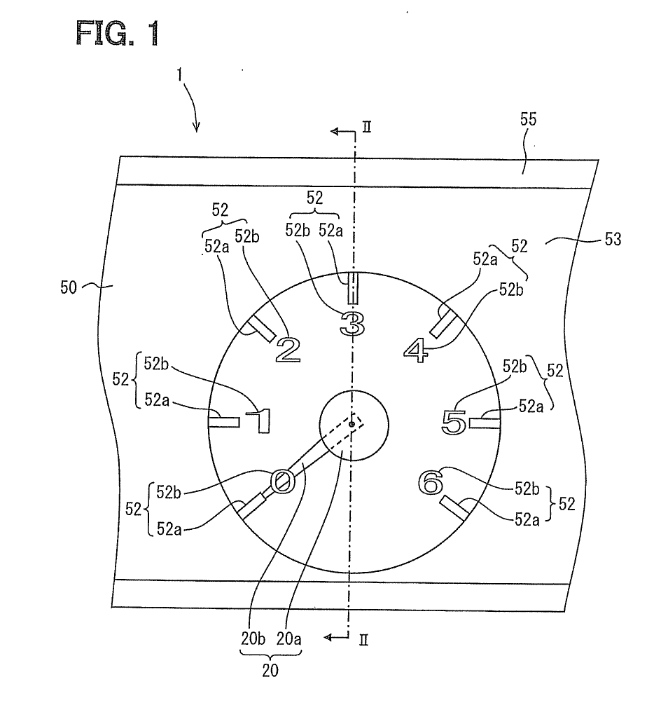

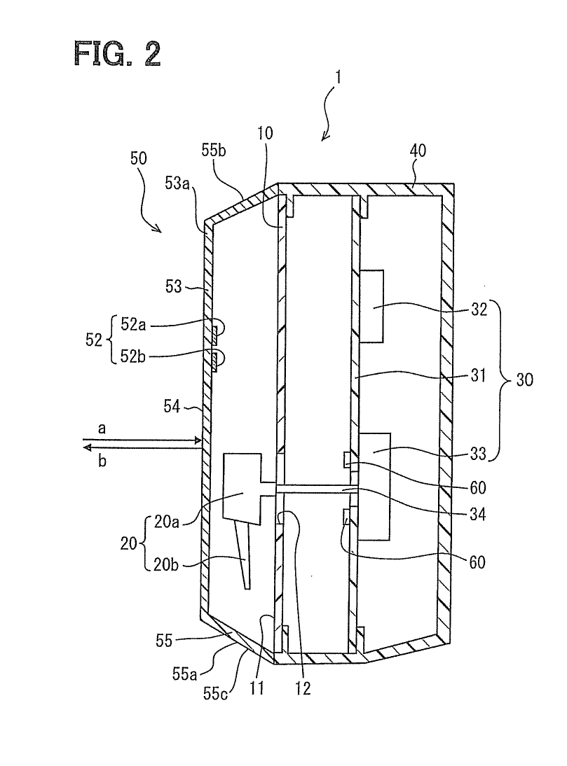

Referring to FIGS. 1 and 2, the first embodiment of the disclosure is a meter 1 for vehicle. The meter 1 is installed in an instrument panel disposed in front of a seat for a driver. In this embodiment, the driver or a passenger of the vehicle is assumed as a viewer of the meter 1. The meter 1 has a front face which faces the viewer, but is directed toward a backward direction of the vehicle. In the following description, a direction from the meter 1 toward the viewer is referred to as a front direction. The meter 1 has components, such as a background board 10, a pointer 20, an electronic-circuit unit 30, a case 40, a cover member 50, and light sources 60.

The background board 10 is formed in a flat plate with resin. The background board 10 is disposed in the case 40 to partition a cavity defined by the case 40 into a back cavity where the electronic-circuit unit 30 is disposed and a front cavity where the pointer 20 is disposed. The background board 10 has a front face 11 which is colored with low brightness color, such as black. The background board 10 may be made from polycarbonate or acrylic resin. The background board 10 is disposed behind the pointer 20 and defines a background surface of a meter appearance.

The pointer 20 is made from resin. The pointer 20 is formed in a thin and long needle shape which is extended from a base end 20a to a distal end 20b. The distal end 20b is thinner than the base end 20a. The pointer 20 displays a value of status of vehicle by pointing one of a plurality of indicators 52. The pointer 20 points one of the indicators 52 at a specific rotational position. The pointer 20 is rotatably supported on the electronic-circuit unit 30. The pointer 20 is placed in front of the background board 10, i.e., on a side region closer to the viewer than the background board 10. The pointer 20 is placed behind the indicator 52, i.e., on a side region more distanced from the viewer than the indicators 52. The pointer 20 is rotatable along a curved path on which the indicators 52 are arranged. The pointer 20 is connected with the driving source 33. The pointer 20 rotates to point at least one of indicators 52. The indicators 52 are scales 52a and numbers 52b showing value of vehicle status, such as such as a vehicle speed or an engine rotational speed. The indicators 52 include independent separate pieces which are formed on the cover member 50, respectively.

The electronic-circuit unit 30 has a circuit board 31 and a controller 32. The circuit board 31 is made of a glass epoxy board etc. The controller 32 is provided by an electronic control unit, such as a microcomputer etc., and is mounted on the circuit board 31. The controller 32 controls the driving source 33 and the light sources 60. The electronic-circuit unit 30 is mounted on the case 40. The electronic-circuit unit 30 is disposed behind the background board 10 in a cavity defined between the background board 10 and the case 40.

The driving source 33 has a shaft 34 which supports the base end 20a of the pointer 20. The shaft 34 is placed to pass through an opening 12 formed on the background board 10. The shaft 34 is placed to penetrate the background board 10. The driving source 33 rotates the shaft 34 and the pointer 20 by being supplied electric power. The driving source 33 is mounted on the circuit board 31. The driving source 33 is arranged behind the circuit board 31 except for a part of the shaft 34. The driving source 33 is provided by combining a reduction-gear mechanism (not shown) and a step motor, for example. The driving source 33 rotates the pointer 20.

The case 40 is formed in the shape of a dish with resin. The case 40 is disposed to cover the circuit board 31 and the controller 32 on a back side of the background board 10. The case 40 is made of resin, such as polypropylene etc.

The light sources 60 may be provided by light emitting diodes, e.g., chip-type LEDs, and are mounted on the electronic-circuit unit 30. The light sources 60 are disposed behind the background board 10. The light sources 60 faces the base end 20a through an opening 12 formed on the background board 10. The light sources 60 are electrically connected with the controller 32, and may be activated and deactivated in response to drive signals supplied from the controller 32. The light sources 60 projects illuminating light, e.g., white light, toward the base end 20a when it is activated. The pointer 20 emits light by guiding and distributing light supplied from the base end 20a toward the distal end 20b. As a result, the pointer 20 is works as a self-illuminated pointer which emits light.

The cover member 50 may be called as a bottomed cylindrical shape. The cover member 50 has a plate 53 and a cylindrical wall 55 surrounding an outer rim of the plate 53. The plate 53 may also be referred to as a front plate 53. The cylindrical wall 55 has a short length. Therefore, the cover member 50 may also be called as a dish shape. The front plate 53 is formed in a flat plate parallel to the pointer 20. The front plate 53 is made of clear or tinted transparent resin. The front plate 53 is located very close to the pointer 20, but still keeps a gap to the pointer 20. The driver and a passenger of the vehicle may be able to see the pointer 20 through the front plate 53 which is transparent. The front plate 53 is covered with an anti-reflective layer 54 which reduces reflection of light. The anti-reflective layer 54 is formed on a front surface of the front plate 53 facing to the viewer. The anti-reflective layer 54 may be provided by using a known anti-reflective coating. Here, the reflection factor of the anti-reflective layer 54 is lower than the reflection factor of the front plate 53. Thereby, it is possible to reduce reflection on the front surface of the front plate 53. Reflection is illustrated by a symbol “b” in FIG. 2. A plurality of indicators 52 are formed on the front plate 53. The indicators 52 are arranged on a curved path. The front plate 53 is made of resin such as acrylic resin etc.

The indicators 52 are placed to be pointed by the pointer 20. The indicators 52 include scales 52a and a plurality of numbers 52b which show a value of vehicle status. The scales 52a are bars radially arranged. The front plate 53 has a back surface which faces the pointer 20. The indicators 52 are formed on the back surface. The indicators 52 are printed on the back surface with a light blocking paint. The indicators 52 are visible in a color different from the color of the background board 10. Visible color of the indicators 52 demonstrates brightness different from the visible color of the background board 10. For example, the visible color of the indicators 52 is bright color such as white.

At least one of the indicators 52 is printed in a size which may makes the indicator to be difficult to understand or read when a portion of the pointer 20, e.g., the distal end 20b, is placed over the indicator. For example, one of the indicators 52 has a size that at least a half area of the indicator may be covered and hidden by the pointer 20. The pointer 20 is disposed behind the indicators 52. Therefore, even if the pointer 20 is rotated to overlaps with one of the indicators 52, the indicator is still placed on a viewer side than the pointer 20. The viewer can recognize the vehicles status value by the indicator placed before the pointer 20.

The cylindrical wall 55 is made of resin. The cylindrical wall 55 extends from an outer rim 53a of the front plate 53. The cylindrical wall 55 expands from the outer rim 53a to an outer rim of the background board 10. An upper portion and a lower portion of the background board 10 are inclined to expand distance therebetween from the outer rim 53a to an upper edge and a lower edge of the background board 10, respectively. An outside surface 55a of the cylindrical wall 55 is painted with paint, such as black. As a result, the cylindrical wall 55 is capable of blocking light. The cover member 50 covers the pointer 20 by the front plate 53 and the cylindrical wall 55 at a front side of the pointer 20 where a viewer is expected to be. The cylindrical wall 55 is made of acrylic resin etc.

The cover member 50 is transparent. The cover member 50 is disposed on a front side to the pointer 20 to cover the pointer 20. The cover member 50 has a back side surface on which the indicators 52 are formed. The cover member 50 defines the front cavity which is formed in a trapezoid and is projected towards the front direction. The cover member 50 gives the meter 1 a projected appearance towards the front direction. The pointer 20, which is protruded from the background board 10, is arranged within the front cavity defined by the cover member 50. The cover member 50 enables the indicator 52, the pointer 20, and the front face 11 of the background board 10 to be illuminated. The indicator 52 positioned most ahead, the background board 10 which provides a background, and the pointer 20 arranged between the indicator 52 and the background board 10 show a perspective appearance, depth in the meter 1, i.e., in the cover member 50. The cylindrical wall 55 is inclined inwardly from the background board 10 to the front plate 53.

The pointer 20 sweeps a circular sweep range. A part of one scale 52a is positioned within the sweep range with respect to a front and back direction of the meter 1, i.e., the viewing direction. The bars of the scale 52a are arranged to overlaps only a part of one bar with the pointer 20. The bar of the scale 52a has a part that is placed on an extended line from the pointer 20.

At least one of the numbers 52b is placed so that the whole of the character is positioned within the sweep range. However, a part of the number 52b is not covered by the pointer 20. The viewer can always see the whole shape of the number 52b. Since the number 20 is printed in the character shape by a light blocking paint and the pointer 20 is self illuminated, when the pointer 20 is placed behind the number 52b, the number 52b is clearly shown as a silhouette. In addition, the number 52b is also illuminated from the front side and shows the character shape by the front surface of the light blocking paint for the number 52b.

The pointer 20 and the indicators 52 are closely arranged with each other with respect to the front and back direction, i.e., the viewing direction. Therefore, even if the meter 1 is viewed from different angles, it is possible to suppress shift of apparent relative positioning between the pointer 20 and the indicators 52. In addition, a distance between the pointer 20 and an inner surface of the front plate 53, where the indictors 52 are formed, is kept constant over the whole sweep range of the pointer 20. Therefore, even if the position of the pointer 20 changes, it is possible to suppress change of the shift of apparent relative positioning between the pointer 20 and the indicators 52.

According to the first embodiment, the cover member 50 covers the pointer 20 from the viewer, and is formed with the indicators 52 which shows the vehicle status value and is pointed by the pointer 20. Since the indicators 52 are placed on a viewer side than the pointer 20, the viewer can see the indicator 52 without being covered with the pointer 20. The viewer can see the indicators 52 certainly. As a result, it becomes easy for the viewer to recognize status values, such as speed, in an instant manner.

If the indicators 52 are formed with sizes which may makes it difficult to understand or read when one of the indicators 52 is overlapped with the pointer 20, and the indicators 52 are placed behind the pointer 20, the problem of the indicators 52 hiding behind the pointer 20 and being hard to see it will become remarkable. However, in the first embodiment, the pointer 20 is placed behind the indicators 52. Therefore, even if one of the indicators has a size which may makes it difficult to understand the content of the indicator 52 when the indicator 52 overlaps with the pointer 20, the viewer can see the indicator 52.

Since the cover member 50, which has the indicators 52, covers the pointer 20 from the viewer, it is possible to provide a new appearance on the meter 1 which is different from a conventional arrangement in which indicators are placed on background board.

The front plate 53, which has the indicators 52, is formed in a flat shape parallel to a rotational plane of the pointer 20. The indicators 52 are formed on a flat surface which is parallel to the rotational plane of the pointer 20. Therefore, a distance between the pointer 20 and the flat surface where the indicators 52 are formed is always kept constant as the pointer 20 rotates. This means that it is possible to suppress change of distance in the front-back direction between the pointer 20 and the overlapping one of the indicators 52. Relative positioning of the pointer 20 and one of the indicators 52 in views from different angles may be different due to the distance therebetween. A shifting amount of relative positioning of the pointer 20 and one of the indicators 52 will be changed as a viewing angle is changed. According to the embodiment, it is possible to reduce a change of the shifting amount of relative positioning of the pointer 20 and one of the indicators 52 in views from different angles. It is possible to keep the shifting amount in constant for all indicators 52 on the circumference along a sweep path of the pointer 20. Change of the shifting amount can be suppressed compared to an arrangement in which the indicators are formed on a surface which is inclined to the rotational plane of the pointer 20. As a result, it is possible to reduce difference of positioning of the pointer 20 and one of the indicators 52 in views from different angles. This may avoid confusion of viewer.

In addition, since the front plate 53 is located close to the pointer 20, the indicator 52 can be also placed close to the pointer 20. It is possible to reduce a shifting amount of relative positioning of the pointer 20 and one of the indicators 52 in views from different angles.

In addition, since the anti-reflective layer 54 covers the front plate 53, it is possible to reduce reflection of light on the front plate 53. Therefore, it is possible to suppress that the viewer may become difficult to see an region on which the indicators are formed due to the reflection on the front plate 53. Therefore, even if light enters with the incident angle of about 90 degrees to the front plate 53, it is possible to reduce brightness of reflection. Entering light is illustrated by a symbol “a” in FIG. 2. It is possible to provide the meter 1 which is capable of improving visibility of the indicators 52.

In this embodiment, since the front plate 53 is flat, light entered into the front plate 53 with the incident angle of about 90 degrees may reflect and may makes the viewer to be dazzle. The front plate 53 covered with the anti-reflective layer 54 can preferably perform the above advantages.

The brightness of the color of the background board 10 visible from the viewer is different from the brightness of the color of the indicators 52. Therefore, the viewer can recognize the difference between the colors of the indicators 52 and the background provided by the background board 10 placed behind both the indicators 52 and the pointer 20. It is possible to provide the meter 1 which has a high level of visibility at the indicators 52.

Since the cylindrical wall 55 blocks light and makes it difficult to see components in the instrument panel through the cylindrical wall 55, it is possible to give a simple appearance of the meter 1. Therefore, it is possible to give the front face of the meter 1 a simple and new ornamental design.

### Second Embodiment

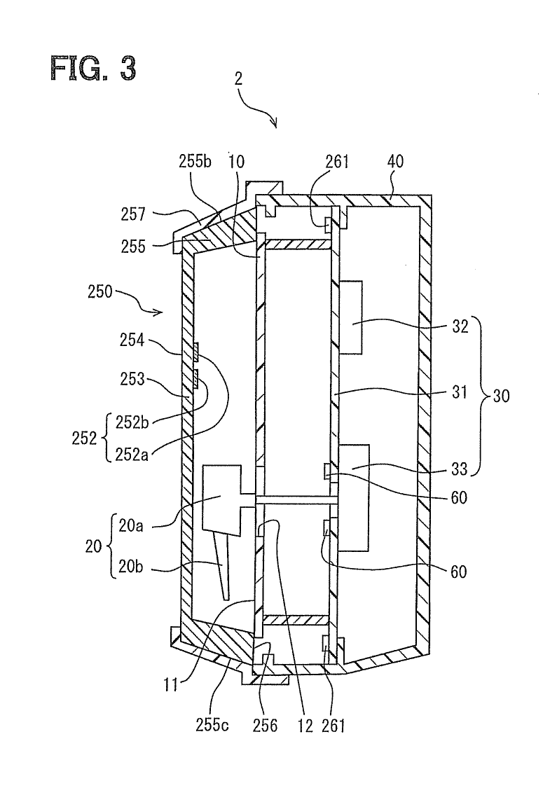

As shown in FIG. 3, the second embodiment discloses a meter 2 which is a modification of the meter 1 in the first embodiment. The meter 2 has a cover member 250 which is a light guide member for guiding light supplied from a light source 261 into an inside thereof. The cover member 250 is a light guide member which guides light to the indicators 52. The cover member 150 has a cylindrical wall 255 having an end face 256. Light entered from the end face 256 of the cylindrical wall 255 is reflected on a front surface of the front plate 253 toward the inside of the cover member 250. The front plate 253 has the front surface which may be placed to face the viewer and a back surface which faces the pointer 20. Indicators 252, which have scales 252a and numbers 252b, are formed, e.g., printed on the back surface. Light reflected toward the inside of the cover member 250 illuminates the indicators 252 from the front side, i.e., a side where the viewer will be.

A plurality of light sources 261 are arranged behind the cylindrical wall 255. The light sources 261 face the end face 256 of the cylindrical wall 255. The light sources 261 are electrically connected with the controller 32, and may be activated and deactivated in response to drive signals supplied from the controller 32. The light sources 261 projects illuminating light, e.g., white light, toward the end face 256 when it is activated. As a result, the indicators 252 are illuminated by light entered from the end face 256 and guided to the front plate 253.

The cover member 250 has the front plate 253 and the cylindrical wall 255 surrounding an outer rim of the front plate 253. The cylindrical wall 255 defines the end surface 256 which receives light. The cover member 250 further has a shield member 257 which covers the cylindrical wall 255 at an outside thereof. The shield member 257 is formed in a cylindrical shape with resin, such as ABS. The shield member 257 is colored low brightness color, such as black, and blocks light. The shield member 257 covers outside surface of the cylindrical wall 255 which inwardly inclined. The cylindrical wall 255 has inwardly inclined outer surface which is placed on an extension line of light emitting direction of the light sources 261. The cylindrical wall 255 has inwardly inclined inner surface which is placed inside to the extension line of light emitting direction of the light sources 261. The shield member 257 further has a flange placed on the front surface of the front plate 253. The flange is placed to cover an area placed on an extension line of the cylindrical wall 255 along the front and back direction. In other words, the shield member 257 covers a surface area from which light from the light sources 261 may leak. The shield member 257 is also attached to the case 40.

The indicators 252 are formed on a surface of the cover member 250 facing the pointer 20. The cover member 250 is the light guide member. The cover member 250 guides light entered from the end surface 256 to a surface facing the pointer 20. The indicators 252 are formed on the surface to which light is guided. Therefore, light from the light sources 261 illuminates the indicators formed on the surface facing the pointer 20. It is possible to illuminate the indicators 252 even in night.

If the indicators 252 are formed on an opposite surface from the pointer 20, light guided by the cover member 250 illuminates the indicator 252 from behind. In that case, the indicators 252 are shown as shadows to the viewer. However, in the meter 2 of the second embodiment, the indicators 252 are formed on the surface facing the pointer 20, and may be illuminated by light from the light sources 261, such as colored light. It is possible to improve visibility of the indicators 252 even in night. It is possible to provide the meter 2 with improved visibility of the indicators 252.

The cover member 250, which is the light guide member, is formed in a bottomed cylindrical shape. The cylindrical wall 255 is covered with the shield member 257 at the outside of the cylindrical wall 255. Therefore, the light entered from the end face 256 may not leak easily from the cylindrical wall 255 to the outside. Therefore, an outer portion of the cover member 250 is prevented from becoming too bright for the viewer. It is possible to improve visibility of the indicators 252 even in night. It is possible to provide the meter 2 with improved visibility of the indicators 252.

### Third Embodiment

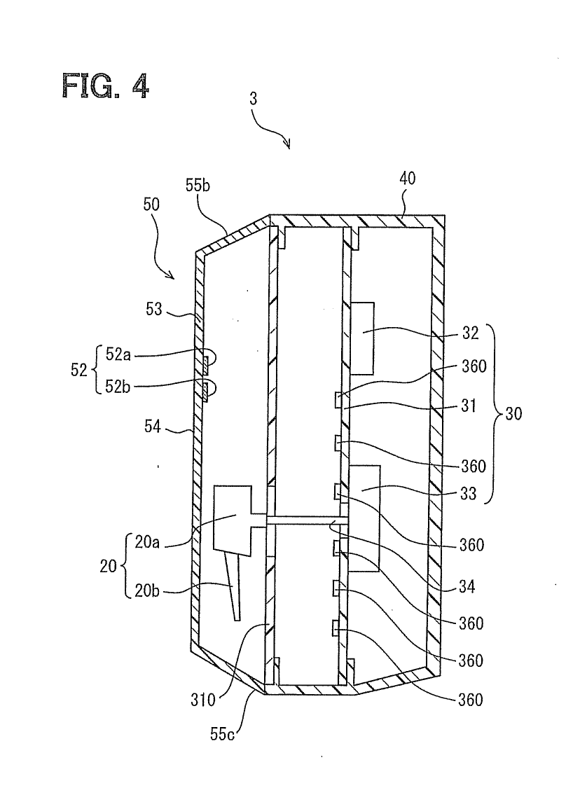

As shown in FIG. 4, the third embodiment discloses a meter 3 which is a modification of the meter 1 in the first embodiment. The background board 310 is translucent. The background board 310 may be made of inherently transparent material, and have a smoky surface layer. For example, the background board 310 may have a smoky print thereon. The meter 3 further has a plurality of light sources 360 disposed behind the background board 310 in order to illuminate the background board 310 from behind. According to the arrangement, the light from the light sources 360 penetrates the background board 310 and illuminates the indicators 52 formed on the cover member 50 from behind, i.e., from a side opposite to a side where the viewer is expected to be.

The background board 310 is translucent, and may supply light from the light sources 360 disposed behind the background board 310 to the indicators 52. The indicators 52 are illuminated from behind. Therefore, it is possible to illuminate the indicators 52 from behind by using simple arrangement, and to improve visibility of the indicators 52 in night.

### Fourth Embodiment

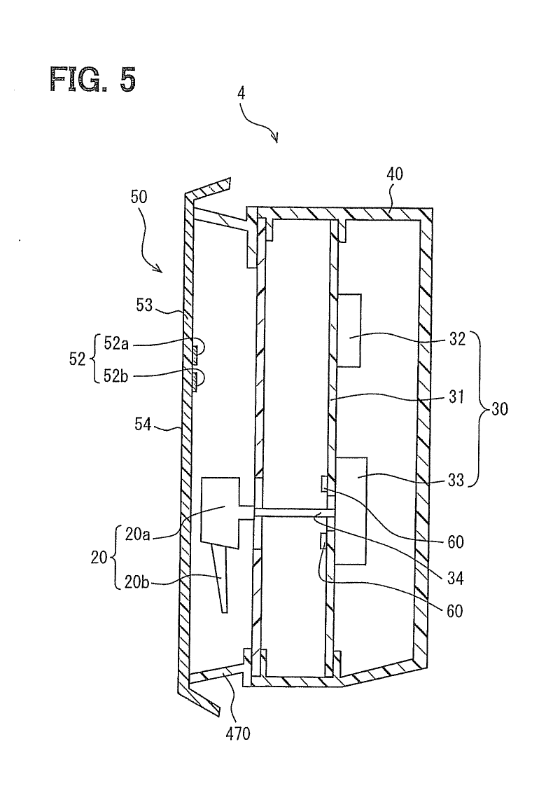

As shown in FIG. 5, the fourth embodiment discloses a meter 4 which is a modification of the meter 1 in the first embodiment. The meter 4 further has a cylindrical shading member 470 which is disposed behind the cover member 50 and is capable of blocking light from entering into the cavity where the pointer 20 is placed. The shading member 470 provides a cylindrical wall and the cover member 50 provides a plate placed on one end of the cylindrical wall. The background board 10 and the cover member 50 are connected by the shading member 470. The shading member 470 is formed into a cylindrical shape with resin, such as ABS or polypropylene. The shading member 470 and the cover member 50 form a bottomed cylindrical shape. The shading member 470 is colored black etc. in order to block light.

The shading member 470 is outwardly inclined from a portion close to the background board 10 toward the front plate 53. The shading member 470 has an inner surface which defines an inner cavity having inner width gradually enlarging from the background board 10 to the front plate 53. Therefore, the viewer may see the inner surface of the shading member 470. Since the inner surface makes the viewer to feel the depth by the perspective representation, it is possible to enhance a three-dimensional appearance among the indicators 52, the pointer 20 and the background board 10.

According to the embodiment, even if someone tries to see the background board 10 and the pointer 20 through portions other than the front plate 53, it is possible to shield the background board 10 and the pointer 20 from viewing by the shielding member 470. Therefore, it is possible to prevent improper view of the meter 4. In addition, the meter 4 may provide a new external appearance.

### Other Embodiments

Although the present invention is described based on the illustrated embodiments, the present invention should not be limited to such embodiments illustrated, may be implemented in other ways and be applied to any combinations and modifications without departing from the scope of the invention.

In the first to third embodiments, the cylindrical walls 55, 255 are inclined outwardly from the front plate 53, 253 to the background board 10. Alternatively, the cylindrical wall 55, 255 may be formed in different inclination. For example, a topside surface 55b, 255b and a bottom side surface 55c, 255c on an top-and-bottom direction of the vehicle may be formed in parallel to each other. The cylindrical wall 55, 255 may be formed in a perpendicular or inclined manner while maintaining the topside surface 55b, 255b and a bottom side surface 55c, 255c in parallel.

In the first to fourth embodiment, the anti-reflective layer 54, 254 is formed on the front plate 53, 253. Alternatively, the anti-reflective layer 54, 254 may be formed on a surface facing the pointer 20. Further, the anti-reflective layer 54, 254 may be omitted. In the third embodiment, the smoky print is formed on the background board 310. Alternatively, the background board 310 may be formed translucent by using one of other different methods. In the fourth embodiment, the shading member 470 is colored black etc. Alternatively, the shading member 470 may be given a light blocking function by using one of other different methods. In the second embodiment, the light guide member 250 guides light from the light sources 261. Alternatively, the light guide member 250 may be formed to guide light from light sources other than the light sources 261. The second and the third embodiments may be combined to provide other embodiment.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A meter with a pointer comprising:
a pointer which rotates to point an indicator showing a value;
a background board disposed behind the pointer;
a driving source which rotates the pointer; and
a cover member which is transparent, is disposed on a front side to the pointer to cover the pointer, and has the indicator thereon.

2. The meter in claim 1, wherein
the cover member has a front plate formed in a flat plate parallel to the pointer, and wherein the indicator is formed on the front plate.

3. The meter in claim 2, wherein
the front plate is covered with an anti-reflective layer which reduces reflection of light.

4. The meter in claim 1, wherein
the indicator is visible in a color different from the color of the background board.

5. The meter in claim 1, wherein
the cover member has a back surface which faces the pointer, and wherein the indicator is formed on the back surface, and wherein
the cover member is a light guide member which guide light to the indicator.

6. The meter in claim 5, wherein
the cover member has a front plate and a cylindrical wall surrounding an outer rim of the front plate, the cylindrical wall defining an end surface into which light is supplied, and the cover member further has a shield member which covers the cylindrical wall at an outside thereof.

7. The meter in claim 1, wherein
the background board is translucent, and wherein the meter further comprises
a light source disposed behind the background board in order to illuminate the background board.

8. The meter in claim 1, further comprising
a cylindrical shading member which is disposed behind the cover member and is capable of blocking light, wherein
the shading member provides a cylindrical wall and the cover member provides a plate placed on one end of the cylindrical wall.

9. The meter in claim 1, wherein
the cover member has a front plate and a cylindrical wall surrounding an outer rim of the front plate, the cylindrical wall being capable of blocking light.
